(19) United States
(12) Patent Application Publication
(10) Pub. No.: US 2026/0060895 A1
(43) Pub. Date: Mar. 5, 2026

(54) CONTAINER SYSTEM FOR PREPARATION OF ACID CONCENTRATE SOLUTIONS

(71) Applicant: Fresenius Medical Care Holdings, Inc, Waltham, MA (US)

(72) Inventors: Evan Harb, Knoxville, TN (US); Kevin Nye, Seymour, TN (US)

(73) Assignee: Fresenius Medical Care Holdings, Inc, Waltham, MA (US)

(21) Appl. No.: 19/317,273

(22) Filed: Sep. 3, 2025

Related U.S. Application Data
(60) Provisional application No. 63/690,321, filed on Sep. 4, 2024.

(51) Int. Cl. A61J 1/10; A61J 1/14; A61J 1/20

(52) U.S. Cl. CPC A61J 1/10; A61J 1/1475; A61J 1/2027; A61J 1/2093

(57) ABSTRACT

A container system used for preparing an acid concentrate solution. The container system includes at least one flexible wall forming a bag that includes at least a first compartment and a second compartment, separated by at least one frangible seal. A nozzle is coupled to the at least one flexible wall and forms a fluid communication to an inside of the bag. A first dry composition is disposed in the first compartment and a second dry composition is disposed in the second compartment. The first dry composition and the second dry composition are components of a dry acid concentrate, and when combined with water, form the acid concentrate solution. The at least one frangible seal is configured to breach upon an internal filling pressure when a threshold amount of liquid is dispensed through the nozzle to the inside of the bag. Water and acid concentrate may flow through one conduit.

### BACKGROUND OF THE INVENTION

This application claims the benefit under 35 U.S. C. § 119(e) of prior U.S. Provisional Patent Application No. 63/690,321 , filed Sep. 4, 2024, which is incorporated in its entirety by reference herein.

The present invention relates generally to container systems that may be used, for example, in preparing and delivering solutions for dialysis.

Dialysis is commonly used to replace kidney function lost by kidney disease. Most importantly, dialysis is designed to remove waste toxins and excess water from the blood. In one type of dialysis—hemodialysis (HD)—toxins are filtered from a patient's blood through a semi-permeable membrane in a dialyzer and into a volume of external dialysis solution. The waste and toxins dialyze out of the blood through the membrane and into the dialysis solution, and the dialysis solution is then discarded.

Peritoneal dialysis (PD) is an alternative method that makes use of the natural, semi-permeable membrane surrounding the walls of the patient's abdomen or peritoneal cavity (i.e., the peritoneum). During a PD procedure, a solution is introduced into the patient's abdomen, where it remains for up to several hours, removing toxins via diffusion across the membrane. This solution is then drained from the body along with the toxins diffused therein.

Dialysis solutions generally include water and glucose, electrolytes (e.g., sodium, calcium, potassium, chlorine, magnesium, and the like), acids (e.g., citric acid, acetic acid, and the like), and/or bases (e.g., bicarbonate). These solutions may be premixed or may be shipped as concentrates or powders to be mixed to a final concentration at a point of use. Premixed solutions are more expensive to ship and store. Shipping and storing concentrates or powders is cheaper and more stable, but increases costs for mixing on-site at the time of use, for example, due to the additional steps of mixing involved by a medical practitioner.

As an example, current bulk dry acid powders are packaged separately in a dextrose bag and blend bag containing salt and electrolytes. The dextrose and the blend containing salt and electrolytes are kept separate to prevent degradation. Mixing requires addition of purified water and agitation over a period of time to ensure a solution is of uniform concentration. As mentioned above, these additional steps increase costs due to the additional steps of mixing.

A need exists for an inexpensive, easy, and safe way to prepare dialysis solutions without a need to ship heavy containers of solution and/or mixing large batches of dry concentrate on-site.

### SUMMARY OF THE PRESENT INVENTION

A feature of the present invention is to provide an inexpensive, easy, and safe way to prepare dialysis solutions without a need to ship heavy containers of solution and/or mixing large batches of dry concentrate on-site.

A further feature of the present invention is to provide a container system for preparation of an acid concentrate solution used during dialysis treatment.

A further feature of the present invention is to provide a container system for preparation of an acid concentrate solution in an amount for a single treatment of dialysis.

An additional feature of the present invention is to provide a container system for preparation of an acid concentrate solution, utilizing a bag that separates components of a dry acid concentrate.

An additional feature of the present invention is to provide a method for preparing an acid concentrate solution by utilizing a bag that separates components of a dry acid concentrate.

A further feature of the present invention is to provide a system for preparing solutions used for dialysis treatment, the system utilizing a dialysis machine and a bag that separates components of a dry acid concentrate.

Additional features and advantages of the present invention will be set forth in part in the description that follows, and in part will be apparent from the description, or may be learned by practice of the present invention. The objectives and other advantages of the present invention will be realized by means of the elements and combinations particularly pointed out in the description and appended claims.

To achieve these and other advantages, and in accordance with the purposes of the present invention, as embodied and broadly described herein, the present invention relates to a container system for preparation of an acid concentrate solution. The container system includes at least one flexible wall forming a bag having at least a first compartment and a second compartment separated by at least one frangible seal that prevents transfer of material between the first compartment and the second compartment until the frangible seal is breached. The flexible wall is water tight. A nozzle is coupled to at least one flexible wall. A first dry composition is disposed in the first compartment and a second dry composition is disposed in the second compartment, which are different from each other. The first dry composition and the second dry composition are components of a dry acid concentrate, and when combined with water, form the acid concentrate solution. The at least one frangible seal is configured to breach upon an internal filling pressure applied when a threshold amount of liquid is dispensed through the nozzle to the inside of the bag.

The present invention, in addition, relates to a method for preparing an acid concentrate solution. The method includes a step of pumping a volume of water from a dialysis machine into a bag through a nozzle of the bag. The bag includes a first compartment containing a first dry composition and a second compartment containing a second dry composition. The first compartment and the second compartment are separated by at least one frangible seal and are different from each other. The at least one frangible seal is breached when a threshold amount of the volume of water is pumped to the first compartment. The acid concentrate solution is formed by a mixing of the volume of water, the first dry composition, and the second dry composition after the at least one frangible seal is breached. The method further includes the step of dispensing the acid concentrate solution from the bag to the dialysis machine through the nozzle.

The present invention, in addition, relates to a system for preparing solutions used for dialysis treatment. The system includes a container and a dialysis machine. The container includes at least one flexible wall forming a bag and a nozzle. The bag includes at least a first compartment containing a first dry composition and a second compartment containing a second dry composition. The first compartment and second compartment are separated by at least one frangible seal that prevents transfer of material between the first compartment and the second compartment until the frangible seal is breached. The dialysis machine is connected to the container by a tube running from the dialysis machine to the nozzle of the container. The dialysis machine is configured to: pump a volume of water through the tube to the container, wherein the at least one frangible seal is configured to breach upon an internal filling pressure applied when a threshold amount of the volume of water is dispensed through the nozzle to the inside of the bag, and the volume of water, the first dry composition, and the second dry composition, when combined, form an acid concentrate solution. The dialysis machine is further configured to receive the acid concentrate solution from the container through the tube.

It is to be understood that both the foregoing general description and the following detailed description are exemplary and explanatory only and are intended to provide a further explanation of the present invention, as claimed.

The accompanying drawings, which is incorporated in and constitute a part of this application, illustrates various features of the present invention and, together with the description, serve to explain the principles of the present invention.

### BRIEF DESCRIPTION OF THE DRAWINGS

The present invention may be more fully understood with reference to the attached drawings that form a part of the present disclosure. The drawings are intended to exemplify, not limit, the invention.

FIG. 1 is a front view of a container system, according to an exemplary embodiment of the present invention.

FIG. 2A is a front view of a bag closure according to an embodiment of the present invention.

FIG. 2B is a cross-sectional view of the bag closure shown in FIG. 2A and taken along line A-A of FIG. 2A.

FIG. 2C is a side view of the bag closure of shown in FIG. 2A.

FIG. 2D is an enlarged view of the bag closure shown in FIGS. 2A-2C, taken along section C shown in FIG. 2C.

FIG. 2E is a top view of the bag closure shown in FIGS. 2A-2D.

FIG. 2F is an enlarged view of the bag closure shown in FIGS. 2A-2E, taken along section B in FIG. 2E.

FIG. 3 is a schematic diagram of a system for preparing solutions used for dialysis treatment illustrating a container and a dialysis machine, according to an embodiment of the present invention.

### DETAILED DESCRIPTION OF THE PRESENT INVENTION

A container system is provided that is used for the preparation of an acid concentrate solution. The container system includes at least one flexible wall forming a bag. The bag includes at least a first compartment and a second compartment separated by at least one frangible seal that prevents transfer of material between the first compartment and the second compartment until the frangible seal is breached. A nozzle is fluidly coupled to the at least one flexible wall.

An all-purpose dry concentrate, which contains all the ingredients required for a dry acid concentrate, is not stable in storage. Therefore, the dry concentrate is separated into partial dry concentrates so that only components that are compatible and stable in storage with one another are present in each partial dry concentrate. A set of concentrates prepared for producing medicinal solutions can thus consist of two, three or more partial dry concentrates (separated from each other with the use of compartments) which are stored in the container or bag.

The partial dry concentrates can at least include a first dry composition disposed in the first compartment and a second dry composition disposed in the second compartment. The first dry composition and the second dry composition are components or solid components of a dry acid concentrate, and when combined with water, form the acid concentrate solution. The at least one frangible seal is configured to breach upon an internal filling pressure applied when a threshold amount of liquid is dispensed through the nozzle to the inside of the bag, such that the first dry composition and the second dry composition combine with the liquid.

The at least one flexible wall forms a bag. The bag can be formed of one flexible wall (e.g., one sheet folded and sealed at the edges), two flexible walls, three flexible walls, four flexible walls, five flexible walls, or more. When formed of one flexible wall, the bag can be a spheroid shape when filled. When the bag is formed of more than one flexible wall, the bag can be formed by a front wall, a rear wall, and a seam connecting the front wall to the rear wall about the periphery of the bag. The seam connecting the front wall to the rear wall about the periphery of the bag can be considered a permanent seam. As an option, the bag can be formed of a front wall, a rear wall, a top wall, a bottom wall, and/or one or more sidewalls, joined together by the permanent seam.

The term “bag” or “container” used herein refers to any type of hollow vessel made of flexible wall materials or flexurally rigid wall materials. As an option, the bag or container can collapse under its own weight and thus can be considered a collapsible container or bag. The collapsible container or bag can be filled with fluids or emptied without any pressure equalization. As an option, the bag or container can be made of a semirigid wall material, which does not collapse under its own weight but is deformable by an applied force.

The bag includes an external surface. The phrase “external surface” is defined herein as the surface of the bag, which can come into contact with its surroundings, such as air, when filled and also when unfilled. The phrase “when filled to the maximum” is defined herein as the maximum size of the bag at which the bag forms no cracks and consequently does not yet tear.

As an option, the bag can be formed of one or more flexible walls, where each of the flexible walls can include one layer, two layers, three layers, four layers, or more layers. The layers can be made of the same material or different materials. For example, one layer can be made of a first polymer and the other or more layers can be made of a polymer, or combination of polymers, that are different from the first polymer. The layers can be laminated or otherwise sealed together.

The one or more flexible walls (not the frangible seals) can have a tear strength in a longitudinal direction of from 200 N/mm to 500 N/mm, from 220 N/mm to 480 N/mm, from 240 N/mm to 460 N/mm, from 260 N/mm to 440 N/mm, from 280 N/mm to 400 N/mm, from 300 N/mm to 350 N/mm, from 310 N/mm to 340 N/mm, from 320 N/mm to 330 N/mm or other tear strengths, or any range based upon any two values described herein. The one or more flexible walls can have a tear strength in a transverse direction of the extrusion of the film of from 180 N/mm to 300 N/mm, from 220 N/mm to 270 N/mm, from 230 N/mm to 260 N/mm, from 240 N/mm to 250 N/mm, or other tear strengths, or any range based upon any two values described herein. Tear strength is measured in the tensile test according to DIN 53455.

As an option, sections of the bag can be produced from a flexurally rigid material. As an option, a side wall of the bag is made from a flexurally stiff material. The flexurally stiff side wall imparts a supporting structure to the bag, which can be advantageous for larger sized bags.

The at least one flexible wall can be made of a polymer material that is water-resistant or water proof. The polymer material can be a food grade material. As examples, the at least one flexible wall can be a plastic material, such as a thermoplastic or thermoplastic elastomer plastic material. The flexible wall can be made of a polyvinyl chloride (PVC), monomaterial ethylene vinyl acetate (EVAM), polyolefin, polyethylene, polypropylene, polyamides, poly-alpha-olefins, hydrogenated styrene block copolymers, copolymers of ethylene, propylene, butene, hexene or octene, styrene-isoprene styrene block copolymer (SIS), styrene-ethylene-butylene block copolymer (SEBS), styrene-ethylene-propylene block copolymer (SEPS), combinations thereof, and the like. For example, the flexible wall can be BIOFINE material.

The bag can be sized to contain a volume, for instance, of from 2 to 8 liters, from 2.5 liters to 7.5 liters, from 3 liters to 7 liters, from 3.5 liters to 6.5 liters, from 4 liters to 6 liters, from 4.5 liters to 5.5 liters or 5 liters, or other amounts, or any range based upon any two values described herein. The bag can be sized to contain the volumes described above when filled to the maximum.

The bag can have a height, for instance, of from 6 inches to 24 inches, from 8 inches to 22 inches, from 10 inches to 20 inches, from 12 inches to 18 inches, from 14 inches to 16 inches, or other heights, or any range based upon any two values described herein.

The bag can have a width, for instance, of from 2 inches to 16 inches, from 4 inches to 14 inches, from 6 inches to 12 inches, from 8 inches to 10 inches, or other widths, or any range based upon any two values described herein.

The bag can have a depth, for instance, of from 0.5 inches to 10 inches, from 1 inch to 8 inches, from 2 inches to 6 inches, from 4 inches to 5 inches, or other depths, or any range based upon any two values described herein.

The at least one flexible wall and/or overall bag can have any degree of flexibility and generally has the same flexibility or rigidity as an IV bag or similar medical fluid containing bag.

The bag can be sterile in its interior. The term “sterile” can mean that the internal bag is freed of or reduced of living microorganisms. The term “sterile” is meant as a reduction in the number of microorganisms capable of multiplying by a factor determined according to typical medical practices. For example, the residual level of microorganisms capable of multiplying in one unit of sterilizing product is at most 1CT6 colony-forming units, i.e. a maximum of one microorganism capable of multiplying can be contained in a million units of identically treated sterilizing product. The sterilization can be carried out by physical (thermal, irradiated) and/or chemical methods.

The bag further includes a bottom end and a top end. The bag is configured to be suspended from the top end, and the nozzle extends through the bottom end into the bag. The bag can further include a support to facilitate maintaining the bag in an upright position. For example, the support can include a hole through the flexible wall, a hook, or other structure adapted to attach to a fixed or movable object (e.g., an IV pole). As an option, the support includes a portion of the seam, to which a clamp or other connecting device can be attached. As an option, a clamp can be used to connect the seam of the bag to the fixed or movable object.

The bag includes at least a first compartment and a second compartment separated by at least one frangible seal that prevents transfer of material between the first compartment and the second compartment until the frangible seal is breached. The frangible seal can be a water tight seal.

As an option, the frangible seal can have a seal strength, for instance, in the range from 0.2 N to 15 N/15 mm. The seal strength can be from 0.2 N to 14 N/15 mm, from 0.2 N to 13 N/15 mm, from 0.2 N to 12 N/15 mm, from 0.2 N to 11 N/15 mm, from 0.2 N to 10 N/15 mm, from 0.2 N to 9 N/15 mm, from 0.2 N to 8 N/15 mm, from 0.2 N to 7 N/15 mm, from 0.2 N to 6 N/15 mm, from 0.2 N to 5 N/15 mm, from 0.2 N to 4 N/15 mm, from 0.2 N to 3 N/15 mm, from 0.2 N to 2 N/15 mm, from 0.2 N to 1 N/15 mm, from 0.2 N to 0.7 N/15 mm, from 0.2 N to 0.5 N/15 mm, from 0.3 N to 15 N/15 mm, from 0.4 N to 15 N/15 mm, from 0.5 N to 15 N/15 mm, from 0.6 N to 15 N/15 mm, from 0.7 N to 15 N/15 mm, from 0.8 N to 15 N/15 mm, from 0.9 N to 15 N/15 mm, from 1 N to 15 N/15 mm, from 1.5 N to 15 N/15 mm, from 2 N to 15 N/15 mm, from 2.5 N to 15 N/15 mm, from 3 N to 15 N/15 mm, from 3.5 N to 15 N/15 mm, from 4 N to 15 N/15 mm, from 4.5 N to 15 N/15 mm, from 5 N to 15 N/15 mm, from 5.5 N to 15 N/15 mm, from 6 N to 15 N/15 mm, from 6.5 N to 15 N/15 mm, from 0.3 N to 11 N/15 mm, from 0.5 N to 8 N/15 mm, from 0.7 N to 7 N/15 mm, from 0.9 N to 6 N/15 mm, from 1.1 N to 5 N/15 mm, from 1.5 N to 4.5 N/15 mm, from 2 N to 4 N/15 mm, from 2.5 N to 3.5 N/15 mm, from 2.8 N to 3 N/15 mm, or other seal strengths, or any range based upon any two values described herein. The term “seal strength” is defined herein as the tensile stress at the moment of the tearing of the frangible seal. The seal strength can be determined by the known methods ASTM D 1876-01, ASTM F88-07 or on the basis of EN ISO 527-3. The force with which a 15 mm wide frangible seal tears is measured in newtons.

The frangible seal can be an internal frangible seal that can include an adhesive connection between two opposing film pieces of the bag. The two opposing film pieces can be joined together by the influence of heat and contact pressure in a welding process using a welding bar. The welding temperature can determine the force with which the frangible seal can be opened. The frangible seal can be an adhesive bond that can be released by applying a force without tearing the at least one flexible wall and the peripheral seam. The frangible seal can be any internal portion of the bag that is fastened together.

As an option, the material of the frangible seal can be the same or different from the material of the at least one flexible wall. The material of the frangible seal can be a food grade material.

The frangible seal of the bag allows the contents of the first compartment and the second compartment to be mixed by simply applying pressure to separate or burst the frangible seal and mix the components together.

The frangible seal requires deliberate pressure to burst the internal connection between the two components, allowing for mix-in-the-bag activation. Contents are kept separate until mixing is required, allowing individually packaged components to remain inert and stable until a perfect mix is made during use.

As an option, the first compartment can be a lower compartment and the second compartment can be an upper compartment. The lower and upper compartment can be considered a gravitational lower and upper compartment. For example, the lower compartment is below the upper compartment when the bag is an upright position, i.e., when the bag is suspended at the top from the fixed or moveable object.

As an option, the first compartment and the second compartment can be side by side, diagonal relative to one another, or in other positions relative to one another. For example, the first compartment can be side by side with the second compartment when the bag is an upright position, i.e., when the bag is suspended at the top from the fixed or moveable object.

As an option, the bag further includes a bottom compartment disposed beneath at least the lower compartment. The bottom, lower, and upper compartment can be considered a gravitational bottom, lower, and upper compartment. For example, the bottom compartment is below the lower compartment, and the lower compartment is below the upper compartment when the bag is an upright position, i.e., when the bag is suspended at the top from the fixed or moveable object.

As an option, the bag can taper towards the nozzle. For example, the bag can have an upper portion that is a rectangular, square, or rounded shape and a lower portion that tapers from the upper portion to a bottom end of the bag where the nozzle is coupled to the flexible wall. For example, the lower portion can be a cone or frustoconical shape when filled and can act as a funnel. The cone or V shape of the taper can have an angle in the range of from 5° to 85° or from 30° to 75°, from 35° to 70°, from 40° to 65° from 45° to 60°, from 50° to 60°, from 55° to 65°, or any range based upon any two values described herein. The taper can allow for the bag to fill at a rapid rate, accompanied by the dissolution of all of the dry concentrates.

In general, the design of the bag and its compartments can contribute to the components mixing together better. The preferred designs described herein are selected since these designs promote the better mixing and dissolving of the ingredients in the water that is introduced.

Alternatively, the entire bag can have a taper and can include a cone or frustoconical shape when filled. In certain embodiments, the upper compartment can be at the upper portion, and the lower compartment and bottom compartment can be at the lower portion. The taper directs liquid to flow out of the bag through the nozzle after the dry components have been mixed with water.

To separate the bottom compartment from the lower compartment, and to separate the lower compartment from the upper compartment, the at least one frangible seal of the present invention can include a first frangible seal and a second frangible seal. The first frangible seal prevents transfer of material between the lower compartment and the bottom compartment until the first frangible seal is breached. The second frangible seal prevents transfer of material between the lower compartment and the upper compartment until the second frangible seal is breached.

The first and second frangible seal can have the same characteristics as the frangible seal described herein. The force required to separate the first and second frangible seal can be the same or different.

As an option, the bag of the present invention can have two compartments or three compartments or more than two compartments, such as three, four, five, six, or more compartments. Additionally, the bag of the present invention can have one, two, three, four, five, or more frangible seals, depending on how many compartments of the bag. Each of the compartments can contain different dry components of a dry concentrate. Further, one or more of the components can be empty.

As an option, the bottom compartment is empty, a first dry composition is disposed in the lower compartment, and a second dry composition is disposed in the upper compartment. The first dry composition and the second dry composition are components of a dry acid concentrate, and when combined with water, form the acid concentrate solution. The at least one orifice of the nozzle forms a fluid communication between the hollow body of the nozzle and the bottom compartment. Due to the option of where the bottom compartment is empty, dry composition is separated from the nozzle (e.g., the dry composition does not contact the nozzle). Such a design feature can better permit the unrestricted entry of water or fluid into the bag without any interference from any part of the dry composition.

As an option, the bottom chamber includes dry components that do not make any contribution to the electrical conductivity of the acid concentrate solution. For example, the bottom chamber can include dextrose, fructose, glucose, sorbitol, osmotically active substances such as water-soluble polymers, for example, polyfructoses, polyglucoses, polyethers and the like. The dry components can be a hydrate form thereof.

The container system can be configured such that when a first threshold amount of liquid is dispensed through the nozzle to the bottom compartment, the first frangible seal is breached forming an intermediate compartment where the liquid is combined with the first dry composition to form an intermediate solution. When a second threshold amount of liquid is dispensed through the nozzle to the intermediate compartment, the second frangible seal is breached, such that the intermediate solution is further combined with the second dry composition to form the acid concentrate solution.

As an example, the first dry composition can be at least one type of osmotic agent. The osmotic agent can include dextrose, glucose, galactose, fructose, acids, amino acids, citric acid, acetic acid, fumaric acid, oxalic acid, malic acid, lactic acid, succinic acid, polymeric osmotic agents (such as polyfructoses, polyglucoses, and polyethers), polyethylene glycol, maltodextrin, icodextrin, or a combination thereof. Where feasible, a hydrate version can be used. For instance, the dextrose can be dextrose monohydrate.

For example, the osmotic agent can be or consist of or consist essentially of a dry glucose or is a dry composition that includes or comprises glucose or hydrate thereof.

For purposes of discussion, the preferred osmotic agent, dextrose, is described, but it is to be understood alternatives to dextrose can be utilized here in the same or similar manner.

The second dry composition can be a dry blend including at least one salt and at least one electrolyte.

The dry dextrose and the dry blend are components of a dry acid concentrate, and when combined with water, form an acid concentrate solution.

The “dry composition” or “dry concentrate” means that the components that form the composition are solid(s) or dry solid components. The components are generally present as a powder, tablets, granules, or particulates. The components are preferably in powder form. The average particle size of the components can be the same or different from each other. The average particle size for each component can be within 1%, 5%, 10%, 15%, or 20% of each other.

The first dry composition and the second dry composition are defined herein as being 99.9% dry or more, 99.99% dry or more, 99.999% dry or more, or 100% dry. In other words, the first dry composition and the second dry composition can each have a moisture content of 0.1 wt% or less, 0.01% or less, 0.001% or less, or can be considered to be moisture free, where the wt% is based on total weight of the composition.

The at least one salt of the dry blend can be sodium chloride, potassium chloride, calcium chloride, magnesium chloride, sodium citrates, sodium lactates, sodium phosphates, sodium carbonates, salts of weak acids, for example, succinates, lactates, acetates, salts of malic acid, oxalates, fumarates, carbonates or bicarbonates or salts of amino acids, or any combinations thereof. A hydrate version can be used. For instance, the magnesium chloride can be a magnesium chloride hydrate and/or the calcium chloride can be a calcium chloride hydrate.

The at least one electrolyte of the dry blend can be sodium, potassium, calcium, magnesium, and/or chloride, or any combinations thereof.

As an option, the first dry composition and the second dry composition are present at a quantity such that when a specified amount of water is introduced into the bag, the first dry composition, the second dry composition, and the water combine to form a volume of the acid concentrate solution for a single dialysis treatment.

Exemplary quantities of the compositions are provided below. The amounts provided can be for the particular component mentioned or a hydrate version thereof.

The quantity of dextrose in the first compartment can be from 100 grams to 500 grams, from 110 grams to 490 grams, from 120 grams to 480 grams, from 130 grams to 470 grams, from 140 grams to 460 grams, from 150 grams to 450 grams, from 160 grams to 440 grams, from 170 grams to 430 grams, from 180 grams to 420 grams, from 190 grams to 410 grams, from 200 grams to 400 grams, from 210 grams to 390 grams, from 220 grams to 380 grams, from 230 grams to 370 grams, from 240 grams to 360 grams, from 250 grams to 350 grams, from 260 grams to 340 grams, from 270 grams to 330 grams, from 280 grams to 320 grams, from 290 grams to 310 grams, or 300 grams, or other amounts, or any range based upon any two values described herein.

The quantity of the dry blend in the second compartment can be from 700 grams to 1,000 grams, or from 750 grams to 1000 grams, or from 800 grams to 1000 grams, from 1000 grams to 2000 grams, from 1050 grams to 1950 grams, from 1100 grams to 1900 grams, from 1150 grams to 1850 grams, from 1200 grams to 1800 grams, from 1250 grams to 1750 grams, from 1300 grams to 1700 grams, from 1350 grams to 1650 grams, from 1400 grams to 1600 grams, from 1450 grams to 1550 grams, or 1400 grams, or other amounts, or any range based upon any two values described herein.

As an example, the dry blend can comprise, consist of, or consist essentially of a dry form of NaCl, KCl, NaH(OAc)₂, MgCl₂ 6H₂O, CaCl₂ 2H₂O, or any combinations thereof.

The quantity of NaCl within the dry blend in the second compartment can be from 500 grams to 1500 grams, from 550 grams to 1450 grams, from 600 grams to 1400 grams, from 650 grams to 1350 grams, from 700 grams to 1300 grams, from 750 grams to 1250 grams, from 800 grams to 1200 grams, from 850 grams to 1150 grams, from 900 grams to 1100 grams, from 950 grams to 1050 grams, or other amounts, or any range based upon any two values described herein.

The quantity of KCl within the dry blend in the second compartment can be from 10 grams to 80 grams, from 15 grams to 75 grams, from 20 grams to 70 grams, from 25 grams to 65 grams, from 30 grams to 60 grams, from 35 grams to 55 grams, from 40 grams to 50 grams, from 45 grams to 48 grams, or other amounts, or any range based upon any two values described herein.

The quantity of NaH(OAc)₂ within the dry blend in the second compartment can be from 40 grams to 160 grams, from 45 grams to 155 grams, from 50 grams to 150 grams, from 55 grams to 145 grams, from 60 grams to 140 grams, from 65 grams to 135 grams, from 70 grams to 130 grams, from 75 grams to 125 grams, from 80 grams to 120 grams, from 85 grams to 115 grams, from 90 grams to 110 grams, from 95 grams to 105 grams, or other amounts, or any range based upon any two values described herein.

The quantity of MgCl₂ 6H₂O within the dry blend in the second compartment can be from 5 grams to 40 grams, from 8 grams to 37 grams, from 10 grams to 35 grams, from 12 grams to 32 grams, from 15 grams to 30 grams, from 18 grams to 28 grams, from 20 grams to 26 grams, from 22 grams to 24 grams, or other amounts, or any range based upon any two values described herein.

The quantity of CaCl₂ 2H₂O within the dry blend in the second compartment can be from 10 grams to 80 grams, from 15 grams to 75 grams, from 20 grams to 70 grams, from 25 grams to 65 grams, from 30 grams to 60 grams, from 35 grams to 55 grams, from 40 grams to 50 grams, from 45 grams to 48 grams, or other amounts, or any range based upon any two values described herein.

As an example, a single dialysis treatment can be a 5-liter treatment volume. The amount of dextrose in the first compartment can be equal to or about 247 grams, the amount of dry blend can be equal to or about 1,489 grams, and the amount of water pumped into the bag can be equal to or about 4.3 liters. Other amounts/volumes within 1%, 3%, 5%, 7%, 10%, 15%, 20% or possible.

The amounts that are provided here for each component and for the stated volumes can be scalable to other volumes.

The acid concentrate solution prepared in the bag of the present invention can meet the requirements of ISO 23500-4: Preparation and quality management of fluids for hemodialysis and related therapies.

The acid concentrate solution resulting from the combination of the dry dextrose, the dry blend, and water can have a pH of from 1 to 4, from 1.5 to 3.5, from 2 to 3, or less than 4.

As an option, the present invention can include a third dry composition, a fourth dry composition, a fifth dry composition, or more dry compositions. The third dry composition, fourth dry composition, fifth dry composition, or more dry compositions can be combined with either the first dry composition, the second dry composition or both, and thus can be present in first compartment and/or the second compartment. As an option, third dry composition, fourth dry composition, fifth dry composition, or more dry compositions can be contained in a third compartment, a fourth compartment, a fifth compartment, or more compartments, respectively, or can be combined in the first compartment, second compartment, or any additional compartment or compartments.

The third dry composition, fourth dry composition, fifth dry composition, or more dry compositions can be a dry acid, such as, but not limited to, a dry diacetate, a dry citric acid, a dry hydrochloric acid, a dry lactic acid, a dry succinic acid, a dry fumaric acid, a dry oxalic acid, a dry acetic acid, a dry malic acid, a dry amino acid, or other dry acid.

Certain solid concentrates undergo unacceptable changes when stored jointly, while others can be stored jointly. As an example, a dry diacetate can be stored jointly with dextrose and thus can be in the same compartment. Other acid dry components should not be stored jointly with dextrose. For example, citric acid should not be stored jointly with dextrose and thus can be stored in a third compartment or another compartment.

Further, bicarbonate salts can be stored separately from the osmotic agent and separately from citric acid. The osmotic agent can be stored separately from citric acid. Sodium chloride can be stored separately from the osmotic agent.

As an option, the container system consists of the first dry composition and the second dry composition, and the first dry composition and the second dry composition consist of components of a dry acid concentrate, and when combined with water, form the acid concentrate solution.

The container system can further include a bag connector. The bag connector can include a main body, a first wing, and a second wing. Each of the first wing and the second wing can extend laterally from opposing sides of the main body. The main body can include an inner surface that defines a nozzle receptacle or a nozzle seat, and an opening that forms a fluid communication between the nozzle receptacle and an outside of the main body.

The thickness of each of the first wing and the second wing can gradually decrease toward opposing ends, such that the bag connector can have a diamond-shaped top, a diamond-shaped bottom, and a diamond-shaped cross-section from top to bottom.

The bag connector can comprise a polymer (e.g., a homopolymer, a copolymer), a polymer blend, a polyalkylene polymer, a polyalkylene blend, polypropylene, or the like.

The nozzle can include a hollow body having a wall that defines an interior volume within the hollow body.

At least one orifice can be formed or provided in the wall, which forms a fluid communication between the interior volume and an outside of the nozzle.

The hollow body can have a generally cylindrical exterior surface and the at least one orifice can extend through the wall of the hollow body. Alternatively, the hollow body can have non-cylindrical shape. The hollow body can have a tube seat to secure a tube therein. The at least one orifice can be a plurality of orifices. Each orifice is capable of forming a fluid connection between an interior volume within the hollow body and an inside of the bag.

The nozzle can comprise a non-polypropylene thermoplastic, for example, polycarbonate, polyvinyl chloride, or the like.

The nozzle can be seated within the nozzle receptacle of the bag connector. The at least one orifice and the opening can be positioned such that a fluid communication is formed between the interior volume of the hollow body, through the orifice, and to outside the bag closure. The hollow body can comprise an outer surface having a cylindrical shape and the nozzle receptacle can be shaped to compliment the cylindrical outer shape of the hollow body.

As mentioned above, the nozzle can further include a tube seat configured to receive and secure a tube therein. The tube seat can comprise a polymeric material, a thermoplastic material, a non-polypropylene thermoplastic, polycarbonate, polyvinyl chloride, or the like. The tube seat can comprise a ledge or shoulder and the bag connector can comprise a bottom edge that is configured and sized to abut the ledge or shoulder. A tube can be bonded to the tube seat, for example, by heat welding, by adhesive bonding, by solvent bonding, by a ring clamp, by a threaded connection, or other attachment mechanism.

As an option, the at least one flexible wall comprises polypropylene, the bag connector comprises polypropylene, and the nozzle comprises a non-polypropylene thermoplastic.

The material of the nozzle can differ from the material of the bag connector, and does not need to bond directly to the material of the at least one flexible wall. The use of one material for the bag connector and a different material for the nozzle enables heat bonding of the bag closure, at the bag connector, to the flexible wall material, and heat bonding of a tube, made of a different material than the flexible wall, to the nozzle. As an example, by making the bag connector of a polypropylene material or that comprises a polypropylene material, the bag connector can readily heat bond to a flexible wall that comprises a polypropylene material, and by making the nozzle of a polycarbonate material, the nozzle can readily bond to a polyvinyl chloride tube. The bag closure can thus bond to two different materials. To enable the bag connector and nozzle to be formed into a leak-free assembly, co-molding methods, over-molding methods, two-shot molding methods, heat bonding methods, solvent bonding methods, 3D printing methods, combinations thereof, and the like, can be used.

As an option, the nozzle is configured as an inlet to dispense liquid to the inside of the bag and is further configured as an outlet to dispense liquid from the inside of the bag. The nozzle can be the single or sole entry point and exit point of the bag.

The nozzle can have a single orifice or multiple orifices and the orifices of the nozzle are configured such that the nozzle can be an inlet and an outlet of the bag. For example, each orifice can be configured to deliver liquid from the interior volume or inner cavity, to the compartment in a direction that is at an angle of from 5° to 85° relative to the longitudinal axis, at an angle of from 15° to 80° relative to the longitudinal axis, at angle of from 25° to 75° relative to the longitudinal axis, or at an angle of from 35° to 65° relative to the longitudinal axis.

Greater details about bag connectors, nozzles, nozzle tips, orifices, and other nozzle and bag closure features that can be used according to the present invention, can be found in U.S. Patent Application Publication No. 2020/0009018 A1 to Jensen et al. and U.S. Patent Application Publication No. 2024/0150084 A1 to Lamb et al., which are incorporated herein in their entirety by reference.

As an option, the container system is absent of any other ports, nozzles, valves, or any other type of fluid access to the bag other than the nozzle.

As an option, the container system is absent of any separate mixing device that is configured to mix water and the components of the dry acid concentrate other than use of the nozzle and introduction of water through the nozzle.

As an option, the container system can further include a dispenser tip, a spout, a tear notch, more than one nozzle, or a user can cut the corner of the bag to release the contents precisely.

The present invention can include a system for preparing solutions used for dialysis treatment. The system can include the container system described herein and a dialysis machine. For example, the system can include a container including at least one flexible wall forming a bag. The container further includes a nozzle having a hollow body and at least one orifice that forms a fluid communication between the hollow body and an inside of the bag. The bag includes at least a first compartment containing a first dry composition and a second compartment containing a second dry composition, the first compartment and second compartment are separated by at least one frangible seal that prevents transfer of material between the first compartment and the second compartment until the frangible seal is breached.

The system further includes the dialysis machine that is connected to the container by a tube running from the dialysis machine to the nozzle of the container. The dialysis machine is configured to: pump a volume of water through the tube to the container, wherein the at least one frangible seal is configured to breach upon an internal filling pressure applied when a threshold amount of the volume of water is dispensed through the nozzle to the inside of the bag, and the volume of water, the first dry composition, and the second dry composition, when combined, form an acid concentrate solution. The dialysis machine is further configured to receive the acid concentrate solution from the container through the tube.

The dialysis machine of the system of the present invention can be any type of dialysis machine. As an example, the dialysis machine is a three-stream hemodialysis machine. As an option, the dialysis machine can be a two-stream hemodialysis machine, a peritoneal dialysis machine, a hemodiafiltration machine, a hemofiltration machine, and the like. The dialysis machine can include standard components of a dialysis machine as well as a valve to direct water into the container and a sensor system/board to deliver a correct amount of volume to the container. The container system can connect via the tube to the dialysis machine by way of a new inlet port of the dialysis machine or an existing hydraulic pathway (i.e., concentrate wand).

A pump of the dialysis machine, such as a deaeration pump, can be used to supply water to the container and pump the acid concentrate solution back to the dialysis machine. The pump can pump liquid at a rate of from 400 mL/min to 1000 mL/min or more, such as 400 mL/min, 500 mL/min, 600 mL/min, 700 mL/min, 800 mL/min, 900 mL/min, or 1000 mL/min.

The temperature of the water that is pumped to the container can be from 30° C. to 50° C., from 32° C. to 48° C., from 34° C. to 46° C., from 36° C. to 44° C., from 38° C. to 42° C., or 40° C.

The dialysis machine is a medical device used to perform dialysis, a treatment that replicates many of the functions of the kidneys. The machine filters and purifies blood by removing waste products, excess fluids, and electrolytes through a semi-permeable membrane, a process known as hemodialysis. During treatment, blood is drawn from the patient's body through a tube, passed through the dialysis machine where it is cleansed, and then returned to the body. This process helps maintain proper chemical balance and prevents the buildup of toxins. Dialysis can be performed in a hospital, a dialysis center, or at home.

As an option, the dialysis machine is further configured to: prepare a dialysate solution by mixing the acid concentrate solution, a bicarbonate concentrate, and water. Dialysis solutions generally include water and glucose, electrolytes (e.g., sodium, calcium, potassium, chlorine, magnesium, etc.), acids (e.g., citric acid, acetic acid, etc.) and/or bases (e.g., bicarbonate). The dialysis solution can be prepared by the dialysis machine using the acid concentrate solution from the container.

As an option, the system is configured to prepare an acid concentrate solution in an amount for a single treatment of dialysis. Thus, the system can be further configured to prepare a dialysis solution in an amount for a single treatment of dialysis.

As an option, the system is absent of any other mixing device that is configured to mix water with the first dry composition and the second dry composition other than the nozzle.

The present invention can further include a method for preparing an acid concentrate solution. The method can include a step of pumping a volume of water from a dialysis machine into a bag, through a nozzle of the bag. The bag can be part of the container system described herein. The method further includes a step of dispensing the acid concentrate solution from the bag to the dialysis machine through the nozzle.

The method of the present invention can further include the following steps: suspending the bag from a top end of the bag, wherein the nozzle extends through a bottom end of the of bag; and connecting a tube from the dialysis machine to the nozzle. The above-mentioned steps can take place prior to pumping the volume of water from the dialysis machine to the bag. In such embodiments, the volume of water is pumped through the tube and the acid concentrate solution is dispensed through the same tube.

The dry dextrose and the dry blend can be present at a quantity such that the volume of water introduced into the bag, combined with the dry dextrose and the dry blend, form a volume of the acid concentrate solution for a single dialysis treatment.

The volume of water that is pumped into the bag can be from 1.5 to 7.5 liters, from 2 liters to 7 liters, from 2.5 liters to 6.5 liters, from 3 liters to 6 liters, from 3.5 liters to 5.5 liters, from 4 liters to 5 liters, or 4.5 liters, or other amounts, or any range based upon any two values described herein.

As an option, the pressure inside the bag acts by supplying the water into the interior of the bag. The water can be RO (reverse osmosis) water.

The threshold amount of the volume of water that can breach the at least one frangible seal can be from 1 liter to 4 liters, from 1.2 liters to 3.8 liters, from 1.4 liters to 3.6 liters, from 1.6 liters to 3.4 liters, from 1.8 liters to 3.2 liters, from 2 liters to 3 liters, from 2.2 liters to 2.8 liters, or from 2.4 liters to 2.6 liters, or other amounts, or any range based upon any two values described herein.

The container system can be configured such that when a first threshold amount of liquid is dispensed through the nozzle to the bottom compartment, the first frangible seal is breached forming an intermediate compartment where the liquid is combined with the first dry composition to form an intermediate solution. When a second threshold amount of liquid is dispensed through the nozzle to the intermediate compartment, the second frangible seal is breached, such that the intermediate solution is further combined with the second dry composition to form the acid concentrate solution.

The first threshold amount of the volume of water that can breach the first frangible seal can be from 1 liter to 4 liters, from 1.2 liters to 3.8 liters, from 1.4 liters to 3.6 liters, from 1.6 liters to 3.4 liters, from 1.8 liters to 3.2 liters, from 2 liters to 3 liters, from 2.2 to 2.8 liters, from 2.4 liters to 2.6 liters, or other amounts, or any range based upon any two values described herein.

The second threshold amount of the volume of water that can breach the second frangible seal can be from 1 liter to 4 liters, from 1.2 liters to 3.8 liters, from 1.4 liters to 3.6 liters, from 1.6 liters to 3.4 liters, from 1.8 liters to 3.2 liters, from 2 liters to 3 liters, from 2.2 to 2.8 liters, from 2.4 liters to 2.6 liters, or other amounts, or any range based upon any two values described herein. The second threshold amount of the volume of water is an amount pumped into the bag after the first threshold amount of water breaches the first frangible seal.

The method of the present invention can further include a step of mixing the acid concentrate solution with bicarbonate concentrate and water to form a dialysis solution after the acid concentrate solution is dispensed to the dialysis machine. Dialysis solutions generally include water and glucose, electrolytes (e.g., sodium, calcium, potassium, chlorine, magnesium, etc.), acids (e.g., citric acid, acetic acid, etc.) and/or bases (e.g., bicarbonate). The dialysis solution can be prepared by the dialysis machine using the acid concentrate solution. In certain embodiments, the method includes preparing an acid concentrate solution in an amount for a single treatment of dialysis. Thus, the method of the present invention can include preparing a dialysis solution in an amount for a single treatment of dialysis.

During the method of the present invention, water flows through the mixing nozzle into the bottom compartment, and as pressure increases, the first frangible seal separates, such that the first dry component falls into the water and dissolves. Pressure increases in the intermediate compartment until the second frangible seal separates, causing the second dry components in the upper compartment to fall into the dissolved intermediate solution. Inlet water continues to flow into the bag, mixing the powder components, until the correct volume has been achieved. Solution then flows back through the nozzle and into the dialysis machine, which provides the acid concentrate during dialysate preparation. After treatment, the container is then emptied and the container can be discarded. No disconnection of tubes or container systems is needed until treatment is complete.

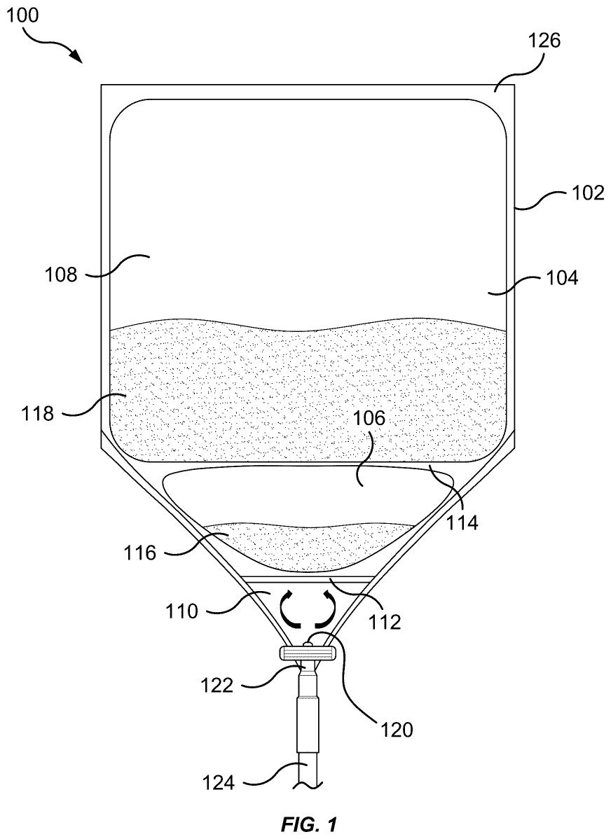

FIG. 1 is a front view of one example of a container system 100, according to an exemplary embodiment of the present invention. Container system 100 is for the preparation of an acid concentrate solution. Container system 100 includes at least one flexible wall 102 forming bag 104. Flexible wall 102 can include a front wall and a rear wall that are joined together along a periphery by a seam 126.

Container system 100 further includes a bag connector 122 including a main body. The main body has an inner surface that defines a nozzle receptacle and an opening that forms a fluid communication between the nozzle receptacle and an outside of the main body. Bag connector 122 is sealed to flexible wall 102 at seam 126. A nozzle 120 is seated within the nozzle receptacle. Nozzle 120 includes a hollow body and at least one orifice that forms a fluid communication between the hollow body and an inside of the bag 104. A tube 124 can be connected to nozzle 120 and can further connect to a dialysis machine.

As illustrated in FIG. 1, bag 104 can include a first compartment 106 and a second compartment 108. A first dry composition 116 is disposed in first compartment 106 and a second dry composition 118 is disposed in second compartment 108. First dry composition 116 and second dry composition 118 are components of a dry acid concentrate, and when combined with water, form the acid concentrate solution.

First dry composition 116 can be a dry dextrose and second dry composition 118 can be a dry blend including at least one salt and at least one electrolyte. The dry compositions can be in a powder form, a granulated form, or the like.

First compartment 106 can be a lower compartment and second compartment 108 can be an upper compartment. The lower and upper compartment can be considered a gravitational lower and upper compartment. As illustrated in FIG. 1, the lower compartment is below the upper compartment when the bag is an upright position.

Bag 104 further includes a bottom compartment 110 disposed beneath the lower compartment. Bottom compartment 110, the lower compartment, and the upper compartment can be considered a gravitational bottom, lower, and upper compartment. As illustrated in FIG. 1 bottom compartment 110 is below the lower compartment, and the lower compartment is below the upper compartment when the bag is an upright position.

A first frangible seal 112 separates bottom compartment 110 from the lower compartment and prevents transfer of material between the lower compartment and the bottom compartment until first frangible seal 112 is breached. A second frangible seal 114 separates the lower compartment from the upper compartment and prevents transfer of material between the lower compartment and the upper compartment until second frangible seal 114 is breached. First frangible seal 112 and second frangible seal 114 are each configured to breach upon an internal filling pressure applied when threshold amounts of liquid are dispensed through nozzle 120 to the inside of bag 104.

FIG. 1 further illustrates that bottom compartment 110 is empty. The at least one orifice of nozzle 120 forms a fluid communication between the hollow body of nozzle 120 and bottom compartment 110. Due to bottom compartment 110 being empty, dry composition is separated from nozzle 120.

Container system 100 is configured such that when a first threshold amount of liquid is dispensed from tube 124 through nozzle 120 to bottom compartment 110, the first frangible seal 112 is breached forming an intermediate compartment where the liquid is combined with first dry composition 116 to form an intermediate solution. When a second threshold amount of liquid is dispensed through nozzle 120 to the intermediate compartment, second frangible seal 114 is breached, such that the intermediate solution is further combined with the second dry composition to form the acid concentrate solution.

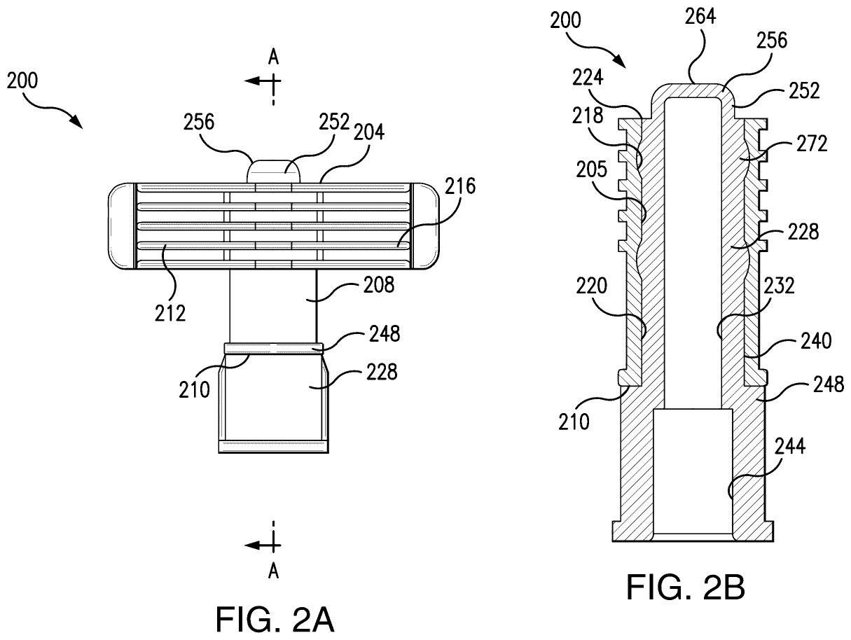

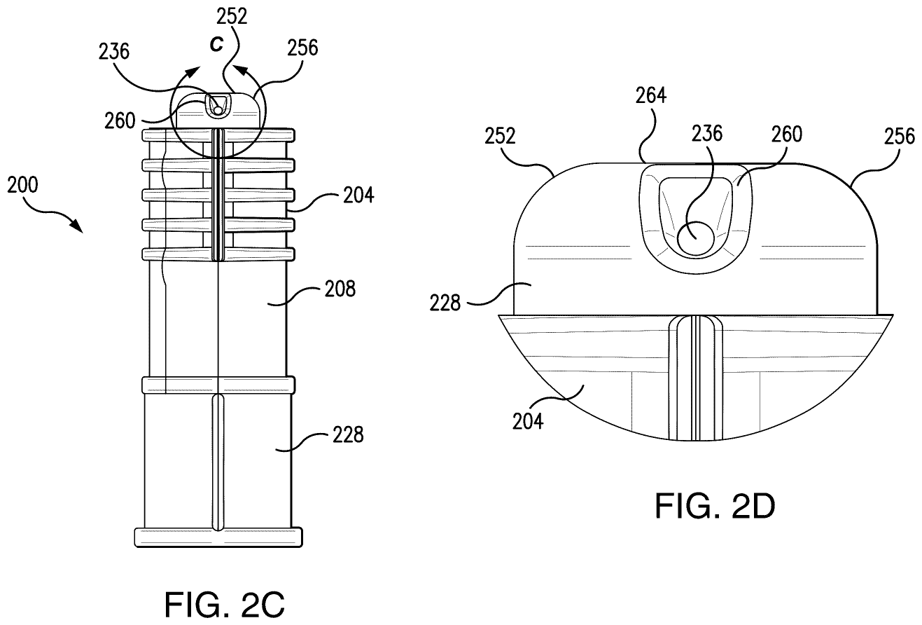

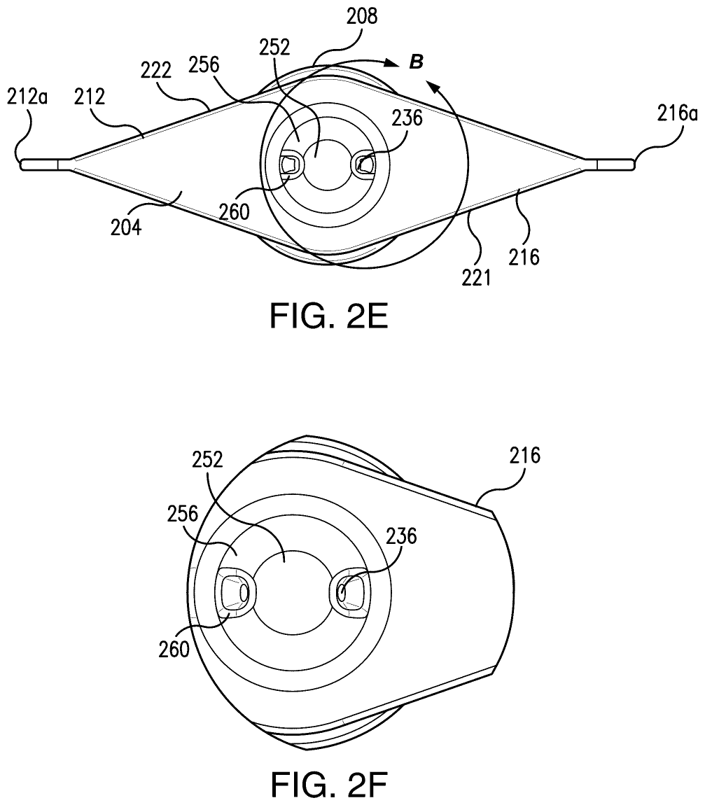

FIG. 2A is a front view of a bag closure 200. According to an embodiment of the present invention. FIG. 2B is an enlarged cross-sectional view of bag closure 200, taken along line A-A of FIG. 2A. FIG. 2C is a side view of bag closure 200 and FIG. 2D is an enlarged sectional view of bag closure 200 taken from section C of FIG. 2C. FIG. 2E is a top view of bag closure 200 and FIG. 2F is an enlarged sectional view of bag closure 200 taken from section B of FIG. 2E.

As shown in FIGS. 2A-2F, bag closure 200 includes a bag connector 204 and a nozzle 228. Bag connector 204 can be made of or otherwise comprise polypropylene, a polypropylene blend, or another material that heat-weld bonds to the material of a polypropylene-containing flexible, for example, the flexible wall illustrated in FIG. 1. Nozzle 228 can be made of a polymer that is different from polypropylene, such as non-polypropylene thermoplastic, polycarbonate, polyvinyl chloride, or the like. Accordingly, nozzle 228 can easily couple to a tube made of the same or a similar material. For example, nozzle 228 can be made of polycarbonate or polyvinyl chloride and the tube that couples to nozzle 228 can also be made of polyvinyl chloride.

Bag connector 204 and nozzle 228 can be manufactured such that bag connector 204 surrounds the side wall of nozzle 228. In such a configuration, bag connector 204 and nozzle 228 are mechanically coupled together and cannot easily be separated from one another. For example, bag connector 204 and nozzle 228 can be manufactured by co-molding bag connector 204 around nozzle 228. Alternatively, forming bag connector 204 around nozzle 228 can comprise over-molding bag connector 204 around nozzle 228. Nozzle 228 and bag connector 204 can be 3D printed, separately, or together. A two-shot molding process can be used. Nozzle 228 can be separately formed, placed in a mold, and then over-molded with a different material to form bag connector 204. Nozzle 228 can be separately formed, and then bag connector 204 can be 3D printed over nozzle 228.

One or more rotation-locking features, for example, fins, can be provided along the outer sidewall of nozzle 228 to prevent nozzle 228 from rotating with respect to bag connector 204 once assembled or molded together. One or more axial displacement locking features can be provided along the outer sidewall of nozzle 228 to prevent nozzle 228 from moving axially with respect to bag connector 204 once assembled or molded together.

Bag connector 204 includes a main body 208, a first wing 212, and a second wing 216. Each of first wing 212 and second wing 216 extends laterally from a respective opposing side of main body 208. Each of first wing 212 and second wing 216 further includes a front face 221 and a rear face 222 as best seen in FIG. 2E. Front face 221 and a rear face 222 are intended to bond to a flexible wall material and can be provided with heat-welding features for this purpose, for example, provided with grooves, conformable ridges, meltable ridges, or the like. Main body 208 includes an inner surface 220 (FIG. 2B) that defines a nozzle receptacle, and an opening 224 that becomes closed-off when assembled together with nozzle 228.

As illustrated in FIG. 2E, a thickness of first wing 212 decreases in a direction from a center of main body 208 toward a distal end 212a of first wing 212, forming a taper. A thickness of second wing 216 decreases in a direction from the center of main body 208 toward a distal end 216a of second wing 216, forming a taper. Distal end 212a of first wing 212 opposes distal end 216a of second wing 216. The tapered first and second wings 212, 216 allow a flexible wall to seal to front face 221 and rear face 222 from distal end 212a to distal end 216a, providing a surface area for heat weld bonding and enabling the flexible wall to bond to bag connector 204 in a manner that forms an air-tight seal to a compartment defined by the flexible wall.

Nozzle 228 includes a hollow body 232 having a wall that defines an interior volume within hollow body 232. At least one orifice 236 forms a fluid communication between the interior volume of nozzle 228 and a volume of a compartment above nozzle 228, that is, above with respect to the orientation shown. As shown in FIGS. 2E and 2F, nozzle 228 can include two orifices 236, or more. As can be seen from FIGS. 2A, 2B, 2C, and 2E, nozzle 228 is seated within the nozzle receptacle 205 of bag connector 204. Orifice 236 of nozzle 228 and opening 224 of bag connector 204 are positioned such that a fluid communication is formed between the interior volume of hollow body 232 and the outside of bag closure 200. When heat welded to a flexible wall, the fluid connection can be formed between the interior volume of hollow body 232 and the inside of a compartment defined by the flexible wall.

Nozzle 228 includes a tip 252. Orifice 236 can be defined through tip 252 of nozzle 228. Tip 252 of nozzle 228 extends through opening 224 of bag connector 204, protruding beyond bag connector 204 such that, when heat welded to a flexible wall, tip 252 is disposed within a compartment defined by the flexible wall, such as the bottom compartment or the lower compartment. As an option, tip 252 is or includes a dome 256. At least one recess 260, for example, two recesses 260, can be formed on respective opposing sides of dome 256. Orifices 236 can be defined within recesses 260 of dome 256, and a flat top surface 264 of dome 256 can be closed, for example, to provide a closed end or closed most distal axial end. Alternatively, dome 256 can have an apex. Thus, orifices 236 direct liquid laterally, or at an angle of less than 90°, from dome 256 and into the compartment formed by the flexible wall.

Bag connector 204 and nozzle 228 complement one another such that bag connector 204 and nozzle 228 are mechanically connected together, forming bag closure 200. For example, hollow body 232 of nozzle 228 can include an outer surface 240 having a cylindrical shape and nozzle receptacle 205 of bag connector 204 defines an interior cylindrical shape that complements the cylindrical shape of outer surface 240 and nozzle 228 can be snugly seated within bag connector 204. Outer surface 240 of hollow body 232 and nozzle receptacle 205 can have other cross-sectional shapes, such as star shapes, polygonal shapes, or any shapes that complement one another.

Outer surface 240 of hollow body 232 and inner surface 220 of main body 208 can have other shapes and structural locking features that complement one another, further securing bag connector 204 and nozzle 228 together. For example, inner surface 220 of main body 208 can further define at least one annular groove 218 within nozzle receptacle 205 and outer surface 240 of the wall of nozzle 228 can have at least one annular protrusion 272 that fits within annular groove 218. As can be seen in FIG. 2B, nozzle receptacle 205 can be provided with more than one annular groove 218, for example two annular grooves 218 or more. Likewise, outer surface 240 of hollow body 232 of nozzle 228 can have more than one annular protrusion 272, for example two annular protrusions 272 or more that complement the annular grooves of nozzle receptacle 205. The annular protrusions 272 fit within annular grooves 218 and further secures bag connector 204 to nozzle 228. Other male and female type connections can further secure bag connector 204 and nozzle 228 together.

Nozzle 228 can further include a tube seat 244 that is shaped to receive and secure a tube therein. For example, tube seat 244 can include an inner wall that defines a tube or cylindrical shape for a conduit or tube to fit within. Tube seat 244 can be formed of a non-polypropylene thermoplastic, for example, polycarbonate or polyvinyl chloride. Thus, a conduit or tube can properly couple to nozzle 228 via tube seat 244. Tube seat 244 can include a ledge 248 and bag connector 204 can include a bottom edge 210 that abuts ledge 248.

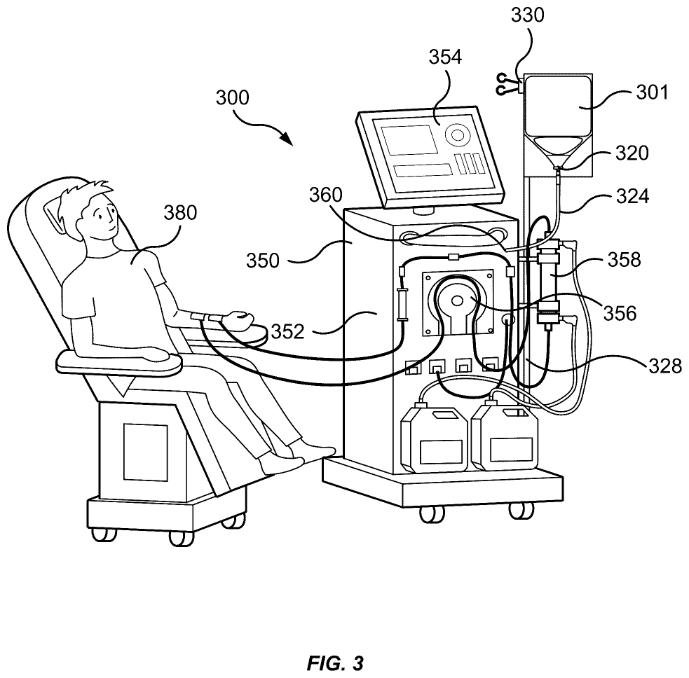

FIG. 3 is a schematic diagram of a system for preparing solutions 300 used for dialysis treatment, illustrating a container 301 and a dialysis machine 350, according to an embodiment of the present invention.

Container 301 includes the same or similar components as the container system 100 described herein and illustrated in FIG. 1.

Dialysis machine 350 is connected to container 301 by a tube 324 running from the dialysis machine 350 to nozzle 320 of the container 301. Dialysis machine 350 can be a three-stream hemodialysis machine, or other type of dialysis machine, such as, but not limited to, a two-stream hemodialysis machine, a peritoneal dialysis machine, a hemodiafiltration machine, a hemofiltration machine, and the like.

Dialysis machine 350 can include a control unit 352, a user interface 354, at least one pump 356, and a dialyzer 358. Control unit 352 can include a processor and a memory and user interface 354 can be used to interface with control unit 352 and dialysis machine 350. Pump 356 can pump fluid to and from the container 301, as well as pump fluid from a patient 380 to the dialyzer 358 and from the dialyzer 358 to patient 380 during treatment. Control unit 352 is configured to control pump 356 such that a specified volume of water is pumped to container 301.

Prior to operation, a top end of container 301 can be suspended to a pole 328 by a clamp 330, such that the upper compartment is above the lower compartment, and the lower compartment is above the bottom compartment. A first end of tube 324 can be connected to nozzle 320 and a second end of tube 324 can be connected to an inlet port 360 of dialysis machine 350.

Dialysis machine 350 is configured to pump a volume of water through tube 324 to container 301. The first frangible seal is configured to breach upon an internal filling pressure applied when a first threshold amount of the volume of water is dispensed through nozzle 320 to the inside of the bag of container 301, forming an intermediate compartment where the liquid is combined with the first dry composition to form an intermediate solution. The second frangible seal is configured to breach upon an internal filling pressure applied when a second threshold amount of the volume of water is dispensed through nozzle 320, such that the intermediate solution is further combined with the second dry composition to form the acid concentrate solution.

Once the acid concentrate solution is formed in container 301, the acid concentrate solution can be pumped from container 301 to dialysis machine 350 through tube 324, flow from container 301 to dialysis machine 350 through tube 324 due to gravity, or a combination thereof. Dialysis machine 350 can further prepare a dialysate solution by mixing the acid concentrate solution, a bicarbonate concentrate, and water. The system can be configured to prepare an acid concentrate solution in an amount for a single treatment of dialysis. Thus, the system can be further configured to prepare a dialysis solution in an amount for a single treatment of dialysis.

### EXAMPLES

### Example 1:5-liter Bag

A bag used to prepare, contain, and deliver 5 liters of acid concentrate solution was manufactured. The bag was made of a flexible wall and included an upper compartment, a lower compartment, and a bottom compartment. The bottom compartment was separated from the lower compartment by a first frangible seal and the lower compartment was separated from the upper compartment by a second frangible seal. A nozzle was connected to the flexible wall at a bottom end of the bag. An orifice of the nozzle formed a fluid communication between a hollow body of the nozzle and the bottom compartment.

The upper compartment contained about 1480 grams to 1490 grams of the dry blend. The dry blend included about 1264 grams of NaCl, about 33.5 grams of KCl, about 128 grams of NaH(OAc)₂, about 22.9 grams of MgCl₂·6H₂O (hydrate), and about 33 grams of CaCl₂·2H₂O (hydrate). The lower compartment contained about 247 grams of dextrose monohydrate. The bottom compartment was empty. The first frangible seal prevented transfer of material between the lower compartment and the bottom compartment. The second frangible seal prevented transfer of material between the lower compartment and the upper compartment

A top end of the bag was clamped to an IV pole. A tube running from a water source of a dialysis machine was inserted into the hollow body of the nozzle. Water was pumped from the water source through the tube and through the nozzle into the bottom compartment. The first frangible seal separated after a first amount of water was pumped into the bottom compartment, forming an intermediate compartment where the dextrose of the lower compartment mixed with the water. The second frangible seal separated after a second amount of water was pumped into the intermediate compartment, and the dry blend of the upper compartment dropped into the water and dextrose mixture. Water continued to be pumped into the bag such that the water, the dry blend, and the dextrose mixed together, until a total of about 4.3 liters of water was pumped into the bag. As a result, the bag contained 5 liters of acid concentrate solution.

The 5 liters of acid concentrate solution was then dispensed from the bag to the dialysis machine through the same nozzle and tube. The 5 liters of acid concentrate solution was combined with other ingredients to form a dialysate in the dialysis machine, and the dialysate was used for a single treatment of dialysis.

### Example 2:3-liter Bag

A bag used to prepare, contain, and deliver 3 liters of acid concentrate solution was manufactured. The bag included the same configuration as Example 1, with an upper compartment, a lower compartment, a bottom compartment, a first frangible seal, a second frangible seal, and a nozzle. The bag of Example 2 was configured to contain 2 liters less acid concentrate solution than the bag of Example 1 and thus included smaller overall dimensions, including a smaller volume for each of the upper compartment, lower compartment, and bottom compartment as compared to Example 1.

The upper compartment contained about 880 grams to 890 grams of the dry blend. The dry blend included about 758.4 grams of NaCl, about 20.1 grams of KCl, about 76.8 grams of NaH(OAc)₂, about 13.7 grams of MgCl₂·6H₂O, and about 19.8 grams of CaCl₂·2H₂O. The lower compartment contained about 148.3 grams of dextrose monohydrate. The bottom compartment was empty.

The bag of Example 2 was connected to the water supply of the dialysis machine by the tube described in Example 1. The same process described in Example 1 occurred in Example 2, except less water was pumped into the bag of Example 2. The 3 liters of acid concentrate solution was then dispensed from the bag to the dialysis machine through the nozzle and tube. The 3 liters of acid concentrate solution was combined with other ingredients to form a dialysate in the dialysis machine, and the dialysate was used for a single treatment of dialysis.

The present invention includes the following aspects/embodiments/features in any order and/or in any combination:
1. A container system for preparation of an acid concentrate solution comprising:
   at least one flexible wall forming a bag comprising at least a first compartment and a second compartment separated by at least one frangible seal that prevents transfer of material between the first compartment and the second compartment until the frangible seal is breached;
   a nozzle coupled to at least one flexible wall, with the nozzle optionally comprising a hollow body and at least one orifice that forms a fluid communication between the hollow body and an inside of the bag;
   a first dry composition disposed in the first compartment; and
   a second dry composition disposed in the second compartment, wherein
   the first dry composition and the second dry composition are components of a dry acid concentrate, and when combined with water, form the acid concentrate solution,
   the at least one frangible seal is configured to breach upon an internal filling pressure applied when a threshold amount of liquid is dispensed through the nozzle to the inside of the bag
2. The container system of any preceding or following embodiment/feature/aspect, wherein the nozzle is configured as an inlet to dispense liquid to the inside of the bag and is further configured as an outlet to dispense liquid from the inside of the bag.
3. The container system of any preceding or following embodiment/feature/aspect, wherein the bag comprises a single entry and exit point at the nozzle.
4. The container system of any preceding or following embodiment/feature/aspect, wherein the nozzle comprises a hollow body and at least one orifice that forms a fluid communication between the hollow body and an inside of the bag.
5. The container system of any preceding or following embodiment/feature/aspect, wherein the hollow body defines a longitudinal axis, and the at least one orifice is oriented at an angle of between 5° and 85° relative to the longitudinal axis.
6. The container system of any preceding or following embodiment/feature/aspect, wherein the at least one orifice is a plurality of orifices each oriented at the angle of between 5° and 85° relative to the longitudinal axis.
7. The container system of any preceding or following embodiment/feature/aspect, wherein the bag further comprises a bottom end and a top end, wherein the bag is configured to be suspended from the top end, and the nozzle extends through the bottom end into the bag.
8. The container system of any preceding or following embodiment/feature/aspect, wherein the first compartment is a lower compartment and the second compartment is an upper compartment.
9. The container system of any preceding or following embodiment/feature/aspect, wherein the bag further comprises a bottom compartment disposed beneath the lower compartment, and the at least one frangible seal is a first frangible and a second frangible seal, wherein the first frangible seal prevents transfer of material between the lower compartment and the bottom compartment until the first frangible seal is breached, and the second frangible seal prevents transfer of material between the lower compartment and the upper compartment until the second frangible seal is breached.
10. The container system of any preceding or following embodiment/feature/aspect, wherein the bottom compartment is empty, and the at least one orifice of the nozzle forms a fluid communication between the hollow body and the bottom compartment.
11. The container system of any preceding or following embodiment/feature/aspect, wherein the container system is configured such that when a first threshold amount of liquid is dispensed through the nozzle to the bottom compartment, the first frangible seal is breached forming an intermediate compartment where the liquid is combined with the first dry composition to form an intermediate solution, and when a second threshold amount of liquid is dispensed through the nozzle to the intermediate compartment, the second frangible seal is breached, such that the intermediate solution is further combined with the second dry composition to form the acid concentrate solution.
12. The container system of any preceding or following embodiment/feature/aspect, wherein the first dry composition is a dry dextrose (or hydrate thereof) and the second dry composition is a dry blend comprising at least one salt and at least one electrolyte.
13. The container system of any preceding or following embodiment/feature/aspect, wherein the quantity of the dry dextrose (or hydrate thereof) is from 150 grams to 400 grams, the quantity of the dry blend is from 1200 grams to 1800 grams, and the bag is sized to contain a volume of 4 to 6 liters.
14. The container system of any preceding or following embodiment/feature/aspect, wherein the first dry composition and the second dry composition are present at a quantity such that when a specified amount of water is introduced into the bag, the first dry composition, the second dry composition, and the water combine to form a volume of the acid concentrate solution for a single dialysis treatment.
15. The container system of any preceding or following embodiment/feature/aspect, further comprising a bag connector comprising a main body, a first wing, and a second wing, each of the first wing and the second wing extend laterally from a respective opposing side of the main body, the main body comprising an inner surface that defines a nozzle receptacle, and an opening that forms a fluid communication between the nozzle receptacle and an outside of the main body, wherein the first wing and the second wing are coupled to the at least one flexible wall, and the nozzle is seated within the nozzle receptacle.
16. The container system of any preceding or following embodiment/feature/aspect, wherein the at least one flexible wall comprises polypropylene, the bag connector comprises polypropylene, and the nozzle comprises a non-polypropylene thermoplastic.
17. The container system of any preceding or following embodiment/feature/aspect, wherein the container system is absent of any other mixing device that is configured to mix water and the components of the dry acid concentrate other than the nozzle.
18. A method for preparing an acid concentrate solution comprising:
   pumping a volume of water from a dialysis machine into a bag through a nozzle of the bag, the bag comprising a first compartment containing a first dry composition and a second compartment containing a second dry composition, the first compartment and the second compartment being separated by at least one frangible seal, wherein
   the at least one frangible seal is breached when a threshold amount of the volume of water is pumped to the first compartment, and
   the acid concentrate solution is formed by a mixing of the volume of water, the first dry composition, and the second dry composition after the at least one frangible seal is breached; and
   dispensing the acid concentrate solution from the bag to the dialysis machine through the nozzle.
19.The method of any preceding or following embodiment/feature/aspect, wherein the first dry composition is a dry dextrose (or hydrate thereof) and the second dry composition is a dry blend comprising at least one salt and at least one electrolyte.
20. The method of any preceding or following embodiment/feature/aspect, wherein the dry dextrose (or hydrate thereof) and the dry blend are present at a quantity such that the volume of water introduced into the bag, combined with the dry dextrose (or hydrate thereof) and the dry blend, form a volume of the acid concentrate solution for a single dialysis treatment.
21. The method of any preceding or following embodiment/feature/aspect, wherein the dialysis machine is a three stream hemodialysis machine.
22. The method of any preceding or following embodiment/feature/aspect, wherein prior to pumping the volume of water from the dialysis machine, the method comprises: suspending the bag from a top end of the bag, wherein the nozzle extends through a bottom end of the of bag; and connecting a tube from the dialysis machine to the nozzle, wherein the volume of water is pumped through the tube and the acid concentrate solution is dispensed through the tube.
23. The method of any preceding or following embodiment/feature/aspect, wherein the first compartment is a lower compartment and the second compartment is an upper compartment.
24. The method of any preceding or following embodiment/feature/aspect, wherein the bag further comprises a bottom compartment disposed beneath the lower compartment, and the at least one frangible seal is a first frangible and a second frangible seal, wherein the first frangible seal prevents transfer of material between the lower compartment and the bottom compartment until the first frangible seal is breached, and the second frangible seal prevents transfer of material between the lower compartment and the upper compartment until the second frangible seal is breached.
25. The method of any preceding or following embodiment/feature/aspect, wherein the first frangible seal is breached when a first threshold amount of water is pumped through the nozzle to the bottom compartment, forming an intermediate compartment where water is combined with the first dry composition to form an intermediate solution, and the second frangible seal is breached when a second threshold amount of water is pumped through the nozzle to the intermediate compartment, such that the intermediate solution is further combined with the second dry composition to form the acid concentrate solution.
26. The method of any preceding or following embodiment/feature/aspect, further comprising mixing the acid concentrate solution with bicarbonate concentrate and water to form a dialysis solution after the acid concentrate solution is dispensed to the dialysis machine.
27. The method of any preceding or following embodiment/feature/aspect, wherein the acid concentrate solution has a pH of less than 4.
28. A system for preparing solutions used for dialysis treatment, the system comprising:
   a container comprising at least one flexible wall forming a bag, and a nozzle, the bag comprising at least a first compartment containing a first dry composition and a second compartment containing a second dry composition, the first compartment and second compartment separated by at least one frangible seal that prevents transfer of material between the first compartment and the second compartment until the frangible seal is breached; and
   a dialysis machine connected to the container by a tube running from the dialysis machine to the nozzle of the container, wherein
   the dialysis machine is configured to: pump a volume of water through the tube to the container, wherein the at least one frangible seal is configured to breach upon an internal filling pressure applied when a threshold amount of the volume of water is dispensed through the nozzle to the inside of the bag, and the volume of water, the first dry composition, and the second dry composition, when combined, form an acid concentrate solution, and
   receive the acid concentrate solution from the container through the tube.
29. The system of any preceding or following embodiment/feature/aspect, wherein the dialysis machine is further configured to: prepare a dialysate solution by mixing the acid concentrate solution, a bicarbonate concentrate, and water.
30. The system of any preceding or following embodiment/feature/aspect, wherein the system is absent of any other mixing device that is configured to mix water with the first dry composition and the second dry composition other than the nozzle.

The present invention can include any combination of the various features and embodiments described herein. Any combination of disclosed features herein is considered part of the present invention and no limitation is intended with respect to combinable features.

Applicants specifically incorporate the entire contents of all cited references in this disclosure. Further, when an amount, concentration, or other value or parameter is given as either a range, a preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

1. A container system for preparation of an acid concentrate solution, the container system comprising:
at least one flexible wall forming a bag comprising at least a first compartment and a second compartment separated by at least one frangible seal that prevents transfer of material between the first compartment and the second compartment until the frangible seal is breached;
a nozzle coupled to at least one flexible wall;
a first dry composition disposed in the first compartment; and
a second dry composition disposed in the second compartment, wherein
the first dry composition and the second dry composition are components of a dry acid concentrate, and when combined with water, form the acid concentrate solution, and
the at least one frangible seal is configured to breach upon an internal filling pressure applied when a threshold amount of liquid is dispensed through the nozzle to the inside of the bag.

2. The container system of claim 1, wherein the nozzle is configured as an inlet to dispense liquid to the inside of the bag and is further configured as an outlet to dispense liquid from the inside of the bag.

3. The container system of claim 1, wherein the bag comprises a single entry and exit point at the nozzle.

4. The container system of claim 1, wherein the nozzle comprises a hollow body and at least one orifice that forms a fluid communication between the hollow body and an inside of the bag.

5. The container system of claim 4, wherein the hollow body defines a longitudinal axis, and
the at least one orifice is oriented at an angle of between 5° and 85° relative to the longitudinal axis.

6. The container system of claim 4, wherein the at least one orifice is a plurality of orifices each oriented at the angle of between 5° and 85° relative to the longitudinal axis.

7. The container system of claim 4, wherein the bag further comprises a bottom end and a top end, wherein the bag is configured to be suspended from the top end, and the nozzle extends through the bottom end into the bag.

8. The container system of claim 7, wherein the first compartment is a lower compartment and the second compartment is an upper compartment.

9. The container system of claim 8, wherein the bag further comprises a bottom compartment disposed beneath the lower compartment, and the at least one frangible seal is a first frangible and a second frangible seal, wherein the first frangible seal prevents transfer of material between the lower compartment and the bottom compartment until the first frangible seal is breached, and the second frangible seal prevents transfer of material between the lower compartment and the upper compartment until the second frangible seal is breached.

10-11. (canceled)

12. The container system of claim 1, wherein the first dry composition is a dry dextrose or hydrate thereof and the second dry composition is a dry blend comprising at least one salt and at least one electrolyte.

13. The container system of claim 12, wherein the quantity of the dry dextrose or hydrate thereof is from 150 grams to 400 grams, the quantity of the dry blend is from 1200 grams to 1800 grams, and the bag is sized to contain a volume of 4 to 6 liters.

14-16. (canceled)

17. The container system of claim 1, wherein the container system is absent of any other mixing device that is configured to mix water and the components of the dry acid concentrate other than the nozzle.

18. A method of preparing an acid concentrate solution comprising:
pumping a volume of water from a dialysis machine into a bag through a nozzle of the bag, the bag comprising a first compartment containing a first dry composition and a second compartment containing a second dry composition, the first compartment and the second compartment being separated by at least one frangible seal, wherein
the at least one frangible seal is breached when a threshold amount of the volume of water is pumped to the first compartment, and
the acid concentrate solution is formed by a mixing of the volume of water, the first dry composition, and the second dry composition after the at least one frangible seal is breached; and
dispensing the acid concentrate solution from the bag to the dialysis machine through the nozzle.

19. The method of claim 18, wherein the first dry composition is a dry dextrose or hydrate thereof and the second dry composition is a dry blend comprising at least one salt and at least one electrolyte.

20. The method of claim 19, wherein the dry dextrose or hydrate thereof and the dry blend are present at a quantity such that the volume of water introduced into the bag, combined with the dry dextrose or hydrate thereof and the dry blend, form a volume of the acid concentrate solution for a single dialysis treatment.

21. (canceled)

22. The method of claim 18, wherein prior to pumping the volume of water from the dialysis machine, the method comprises:
suspending the bag from a top end of the bag, wherein the nozzle extends through a bottom end of the of bag; and
connecting a tube from the dialysis machine to the nozzle, wherein
the volume of water is pumped through the tube and the acid concentrate solution is dispensed through the tube.

23. The method of claim 18, wherein the first compartment is a lower compartment and the second compartment is an upper compartment.

24-25. (canceled)

26. The method of claim 18, further comprising mixing the acid concentrate solution with bicarbonate concentrate and water to form a dialysis solution after the acid concentrate solution is dispensed to the dialysis machine.

27. The method of claim 18, wherein the acid concentrate solution has a pH of less than 4.

28. A system for preparing solutions used for dialysis treatment, the system comprising:
a container comprising at least one flexible wall forming a bag, and a nozzle, the bag comprising at least a first compartment containing a first dry composition and a second compartment containing a second dry composition, the first compartment and second compartment separated by at least one frangible seal that prevents transfer of material between the first compartment and the second compartment until the frangible seal is breached; and
a dialysis machine connected to the container by a tube running from the dialysis machine to the nozzle of the container, wherein
the dialysis machine is configured to:
pump a volume of water through the tube to the container, wherein the at least one frangible seal is configured to breach upon an internal filling pressure applied when a threshold amount of the volume of water is dispensed through the nozzle to the inside of the bag, and the volume of water, the first dry composition, and the second dry composition, when combined, form an acid concentrate solution, and
receive the acid concentrate solution from the container through the tube.

29. The system of claim 28, wherein the dialysis machine is further configured to:
prepare a dialysate solution by mixing the acid concentrate solution, a bicarbonate concentrate, and water.

30. The system of claim 28, wherein the system is absent of any other mixing device that is configured to mix water with the first dry composition and the second dry composition other than the nozzle.

31. (canceled)
